(19) United States
(12) Patent Application Publication
(10) Pub. No.: US 2015/0195998 A1
(43) Pub. Date: Jul. 16, 2015

(54) GROMMET FOR A SHEET MATERIAL

(71) Applicant: Extenday IP Limited, Auckland (NZ)

(72) Inventor: Jonathan Dallas Toye, Auckland (NZ)

(21) Appl. No.: 14/597,096

(22) Filed: Jan. 14, 2015

(30) Foreign Application Priority Data
Jan. 14, 2014 (NZ) 619956

(51) Int. Cl. A01G 13/00; F16B 43/00

(52) U.S. Cl. CPC A01G 13/0206; F16B 43/00

(57) ABSTRACT

A grommet adapted to be assembled with a sheet material around an aperture in the sheet material is described. The grommet comprises a first flange and a second flange adapted to be assembled together with the sheet material positioned between. The first flange comprises locking pins to extend through the sheet material around the aperture and the second flange comprises corresponding holes for receiving the locking pins. Each locking pin comprising a rim that bears against a corresponding surface of the second flange to hold the flanges together.

### PRIORITY CLAIM

This invention claims priority from New Zealand Application Serial No. 619956 filed Jan. 14, 2014, which is hereby incorporated by reference.

### FIELD OF THE INVENTION

The invention relates to materials for use over growing plants such as grape or berry or other fruit vines, bushes, or fruit trees (herein: plants) in agricultural applications.

### BACKGROUND OF THE INVENTION

A canopy comprising sheet material is used over growing plants to provide protection against weather, for example rain, hail and solar radiation. In use a canopy is supported over the plant(s), for example by clipping or otherwise attaching lengthwise edges of the material to cables or wires along rows of plants on either side, in a garden, field crop, orchard or vineyard. A central portion of the canopy may be supported over one or more of a post, posts, cable or line. A canopy will typically remain in place for some months, before being removed and reused in a subsequent growing season or on another crop in the same growing season, but in some cases may remain in place over multiple growing seasons.

In some uses a canopy with air vents may be desirable. Air vents in the canopy allow air flow to pass through the canopy. Allowing air to pass through the canopy may reduce a buildup of pressure under than canopy in windy conditions, which may allow lower strength fasteners to be used to secure the canopy over a plant or plants. Also, air vents may prevent a buildup of warm or hot air underneath the canopy which may be undesirable.

Vents or vent apertures in a canopy must be robust to prevent the aperture from causing a tear in the canopy sheet material. A vent aperture may be supported by a grommet in the sheet material. Forming robust vents or vent apertures in a canopy can be labour intensive. Furthermore it may be desirable to provide a cover over a vent aperture to prevent rain passing through the aperture.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

The present invention provides an improved canopy or an improved grommet for reinforcing a vent aperture in a canopy, or an improved type of vent and venting system, or at least to provide the public with a useful choice.

### SUMMARY OF THE INVENTION

In one aspect, the present invention consists in a grommet adapted to be assembled with a sheet material around an aperture in the sheet material comprising:

a first flange and a second flange adapted to be assembled together with the sheet material positioned between, the first flange comprising locking pins to extend through the sheet material around the aperture and the second flange comprising corresponding holes for receiving the locking pins, each locking pin comprising a rim that bears against a corresponding surface of the second flange to hold the flanges together.

In some embodiments the rim is positioned on the locking pin to set a gap between the flanges that is dimensioned to hold the sheet material between the flanges.

In some embodiments the rim is positioned on the locking pin to set a gap between the flanges that is smaller than the thickness of the sheet material

In some embodiments the first flange has a plurality of locking pins spaced apart around a circumference of the flange.

In some embodiments the rim locks or bears against a recessed surface of the second flange.

In some embodiments an end of the locking pin is flush or is recessed.

In some embodiments the rim locks or bears against a surface of the second flange recessed from a side of the second flange so that an end of the locking pin does not protrude from the side of the flange.

In some embodiments the locking pins are adapted to pierce through the sheet material.

In some embodiments the first and second flanges comprise complementary features for aligning the flanges together.

In some embodiments one of the first and second flanges comprises at least two alignment pins and the other one of the first and second flanges comprises corresponding alignment holes for receiving the alignment pins.

In some embodiments the alignment pins comprise a tapered end.

In some embodiments the alignment pins are longer than the locking pins.

In some embodiments an end of the alignment pin is flush or is recessed.

In some embodiments the other one of the first and second flanges comprises a raised annular portion on an outer side around the alignment hole so that the tip of the alignment pin is recessed or flush.

In some embodiments one of the first and second flanges comprises at least one projection and the other one of the first and second flanges comprises a corresponding recess for receiving the projection to provide a non-linear gap between the flanges for receiving the sheet material.

In some embodiments one of the first and second flanges comprises a plurality of projections and the other one of the first and second flanges has a corresponding plurality of recesses for receiving the plurality of projections to provide a non-linear gap between the flanges for receiving the sheet material.

In some embodiments the projections and corresponding recesses are spaced apart around a circumference of the flanges.

In some embodiments each projection and corresponding recess extends circumferentially for a portion of a circumference around the flanges.

In some embodiments the projections and the locking pins are alternately spaced apart on a circumference around the flange.

In another aspect the present invention broadly consists in a grommet and vent cover, the grommet as described in any one or more of the above statements, the vent cover adapted to be attached to the grommet to cover the aperture.

In some embodiments the vent cover is attached to one of the first and second flanges by a hinged portion.

In some embodiments the vent cover, hinged portion and one of the first and second flanges is integrally formed, the vent cover folded about an edge of the flange to lie over the aperture.

In some embodiments the vent cover is removably attached to one of the first and second flanges.

In some embodiments the vent cover comprises a tab or pin to be received in a hole or slot in one or both of the first and second flanges.

In some embodiments the tab has a broad end or head or is approximately T shaped to retain the tab in the hole or slot once the head is inserted through the hole or slot.

In some embodiments the tab or pin comprises a slot to allow sides of the tab or pin to deflect inwards so that the head of the tab or pin can be inserted through the hole or slot.

In some embodiments the tab or pin extends from an edge of the vent cover.

In some embodiments the tab or pin extends from an inner surface of the vent cover.

In some embodiments the tab or pin engages a slot or hole in one of the first and second flanges and an end of the pin is flush or recessed from an inner side of the first or second flange.

In some embodiments, in a closed position over the aperture the vent cover is in an un-deflected position, the vent cover adapted to deflect elastically to bend away from the aperture, the stiffness of the vent cover biasing the vent cover to the closed position.

In some embodiments the grommet comprises a slot or hole at each side of the first flange or the second flange or both, and the cover comprises a tab at each side of the cover to engage the slot or hole at each side of the flanges.

In some embodiments the vent cover comprises a lateral dimension between the tabs that is greater than a lateral dimension between the slots or holes at each side of the flanges so that when the vent cover is attached to the flanges the vent cover arches or bows outwardly from the aperture.

In some embodiments the vent cover arches or bows outwardly from the aperture.

In some embodiments the grommet comprises at least two said holes or slots on one side of the first or second flange.

In some embodiments the grommet comprises at least two said holes or slots at each side of the first or second flange.

In some embodiments the vent cover comprises a longitudinal dimension greater than a longitudinal dimension of the aperture.

In some embodiments the vent cover extends longitudinally beyond the first or second flange.

In some embodiments the longitudinal dimension of the vent cover is at least 1.5 times the diameter or the longitudinal dimension of the aperture.

In some embodiments the longitudinal dimension of the vent cover is at least 2 times the diameter or the longitudinal dimension of the aperture.

In another aspect the present invention consists in a canopy comprising a sheet material having a greater length than width, a plurality of apertures in the sheet material, and a grommet provided around each said aperture as described above.

In some embodiments the canopy comprises preformed holes around the aperture for receiving the locking pins.

In some embodiments the aperture is formed in the sheet material after the grommet has been assembled to the sheet material.

In some embodiments the aperture is formed in the sheet material before the grommet is assembled to the sheet material.

In another aspect the present invention consists in a canopy comprising a sheet material having a greater length than width, a plurality of vent apertures in the sheet material, and a plurality of grommets and vent covers, each grommet provided around each said vent aperture, each grommet and vent cover as described above.

In some embodiments the vent cover comprises a tab to be received in a hole or slot in one or both of the first and second flanges, and the sheet material comprises a hole aligned with the hole or slot in the first or second flange so that in use the tab of the cover extends through the hole or slot in the first or second flange and through the aligned hole in the sheet material.

The term “comprising” as used in this specification and claims means “consisting at least in part of”. When interpreting each statement in this specification and claims that includes the term “comprising”, features other than that or those prefaced by the term may also be present. Related terms such as “comprise” and “comprises” are to be interpreted in the same manner.

As used herein the term “and/or” means “and” or “or”, or both.

As used herein “(s)” following a noun means the plural and/or singular forms of the noun.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

The invention consists in the foregoing and also envisages constructions of which the following gives examples only.

### BRIEF DESCRIPTION OF THE DRAWINGS

Preferred embodiments of the invention will be described by way of example only and with reference to the drawings, in which:

FIG. 1 is a schematic perspective view of a canopy fixed over a central ridge of poles and spanning a ridge cable, and with vent apertures near the centre, middle of each side and each edge of the canopy. The canopy material is translucent or partly translucent and the supporting structure can be seen through the canopy.

FIG. 2 is a schematic perspective view of a canopy fixed over a central ridge of poles and spanning a ridge cable, and with vent apertures near the centre of the canopy and near the edges of the canopy.

FIG. 3 is a schematic perspective view of a canopy fixed below a ridge cable supported by a support structure, and with vent apertures near the centre, middle of each side and each edge of the canopy.

FIG. 4 is a perspective view of a flange of a grommet for a vent aperture in a canopy according to some embodiments of the present invention.

FIG. 5 is an enlarged view of part of the flange of FIG. 4.

FIG. 6 is a perspective view of a second flange of a grommet for a vent aperture in a canopy according to some embodiments of the present invention.

FIG. 7 is a perspective view of the flange of FIG. 6 viewed from an underside of the flange.

FIG. 8 is a perspective view of a grommet for a vent aperture in a canopy according to some embodiments of the present invention comprising the flanges of FIGS. 4 and 6. FIG. 8 illustrates an underside of the grommet.

FIG. 9 is a perspective part view of the grommet of FIG. 8 and a vent cover for covering a vent aperture provided by the grommet.

FIG. 10 is a perspective view of the grommet of FIG. 8 attached to part of a sheet material of a canopy according to some embodiments of the present invention, and a vent cover detached from the grommet. The grommet is provided around a vent aperture in the canopy.

FIG. 11 is a perspective view of the grommet and cover of FIG. 10 with the vent cover attached to the grommet.

FIG. 12 is another perspective view of the grommet and cover of FIG. 10 with the vent cover attached viewed from below the grommet.

FIG. 13 is a side view of the grommet and cover of FIG. 10 with the vent cover attached.

FIG. 14 is a perspective view of the grommet and cover of FIG. 10 with the vent cover shown in two configurations, detached and attached to the grommet.

FIG. 15 is a part perspective view of the grommet and cover of FIG. 10 with the vent cover attached to the grommet and viewed from below the grommet.

FIG. 16 is a perspective view of a flange of another grommet for a vent aperture in a canopy according to some embodiments of the present invention.

FIG. 17 is a side view of the flange of FIG. 16.

FIG. 18 is a perspective view of a grommet comprising the flange of FIGS. 16 and 17 attached to part of a sheet material of a canopy according to some embodiments of the present invention.

FIG. 19 is a perspective view of a vent cover for a grommet.

FIG. 20 is a perspective part view of the vent cover of FIG. 19.

FIG. 21 is a perspective part view of the vent cover of FIG. 19 attached to the flange of FIG. 4.

FIG. 22 is a perspective view of the grommet of FIG. 8 assembled with a sheet material and with the vent cover of FIG. 19 attached, the grommet viewed from below.

FIG. 23 is a perspective view of the grommet of FIG. 8 assembled with a sheet material and with the vent cover of FIG. 19 attached, the grommet viewed from above and with the vent cover in an un-deflected position.

FIG. 24 is a similar perspective view to that of FIG. 23, but with the vent cover in a deflected position, deflected under wind or air pressure.

### DETAILED DESCRIPTION

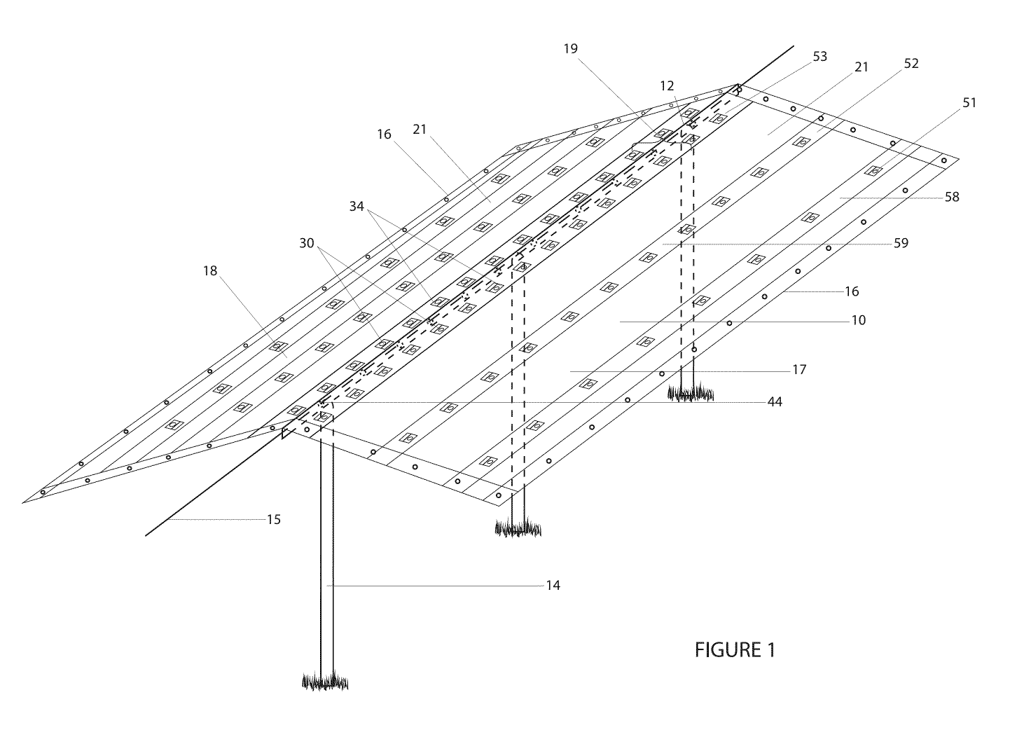

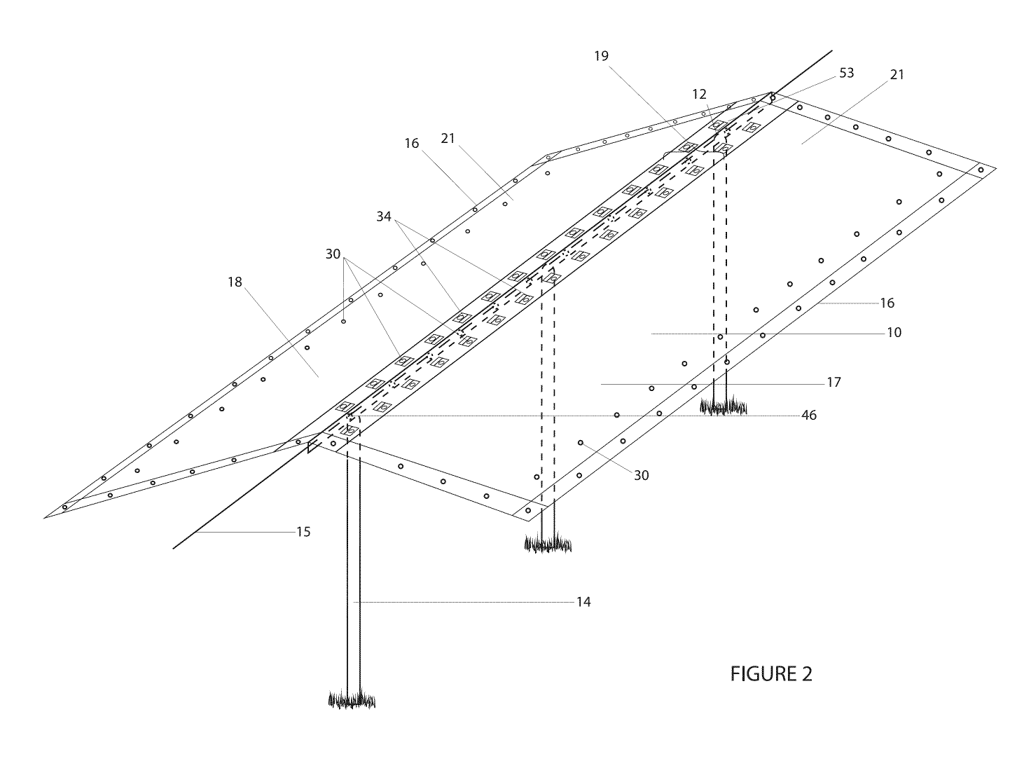

Referring to FIGS. 1 to 3 a canopy 10 can be fixed over rows of for example berry vines or bushes. Typically the canopy has a greater length than width, and is provided for use, as a roll or in concertina folded form. In use the canopy may be supported along a ridge line 12 or peak by a combination of posts 14 and wires or cables 15 that extend between the posts. The canopy may be attached to the wire under the canopy to 44 and the wire is supported by posts 14. Longitudinal edges of the canopy may be held in a stretched out condition by guys or fasteners connecting between the edge 16 of the canopy and any suitable securing point on the ground or on an adjacent frame or wire extending down the row length and/or across the row width. In this form the canopy forms a ridge with two major surfaces or sides 17, 18 as shown in FIGS. 1 and 2 sloping away from the ridge line. The canopy is particularly intended for shedding water to provide partial shelter for the plants underneath. The canopy is particularly suited to use over ripening berry fruit or other fruits grown on trees. The canopy will typically remain in place for some months, before being removed and reused in a subsequent growing season or on another crop in the same growing season, but in some cases may remain in place over multiple growing seasons.

The sheet material may be woven from flat warp and weft tapes of a plastics material that could be later coated in plastic film on one or both sides; or not coated. Alternatively the sheet material could be plastics film. If the sheet material is woven from tapes, the tapes may be formed by extruding a film material from a polymer resin and then cutting the film into tapes which are in turn used to weave the material, or by extruding individual tapes. The tapes may be formed from a polymer containing pigments which give the canopy material desired properties, such as desired light reflective, absorptive, transmission and/or diffusive properties for example.

In the illustrated embodiments the canopy includes securing features 44. In particular the canopy includes a flap 46 extending from the centre of the canopy. At least one securing feature 44 is located in or on the flap. The flap extends for substantially the whole, or at least a majority, of the length of the canopy. In some embodiments a series of independent flaps may be provided dispersed along the length of the canopy.

In the illustrated embodiments, at least one securing feature is an aperture in the flap 46. The aperture may be provided with reinforcing such as a plastic or metal eyelet or grommet. Alternatively the securing feature might be a hook or clip or tag line bonded or sewn to a flap, or bonded or sewn directly to the canopy.

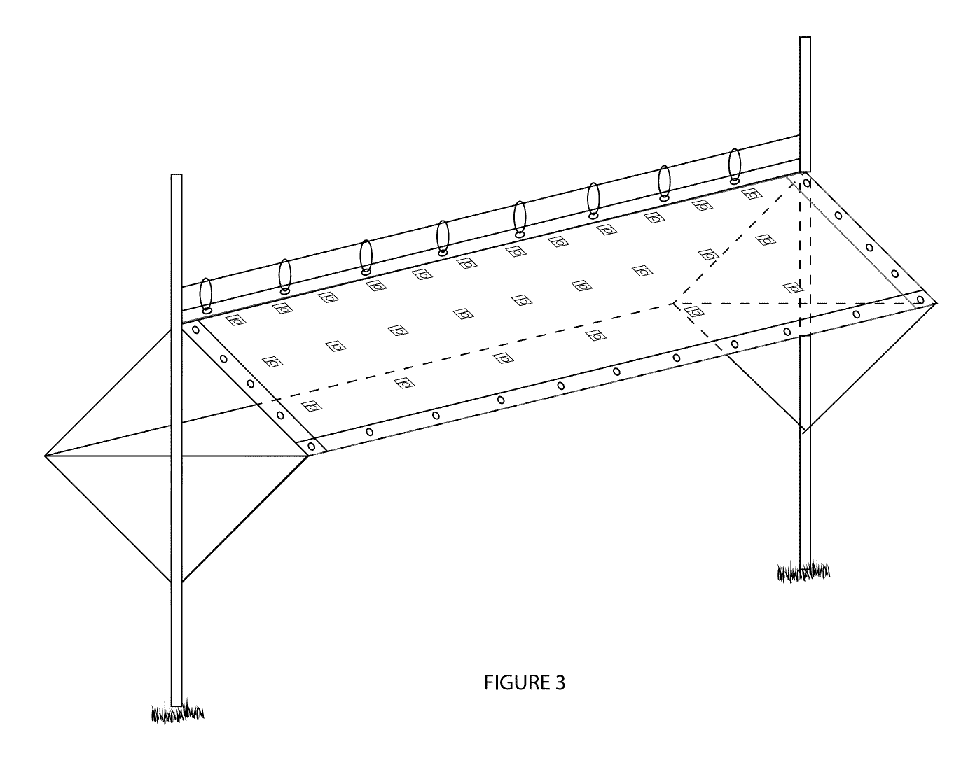

In some embodiments as shown in FIGS. 1 and 2 the flap 46 extends below the canopy. In use, the securing features 44 in the flap are connected to the supporting ridge wire or to the supporting poles below the canopy. This ensures that the centre portion of the canopy stays in position over the ridge wire and/or supporting poles. In some embodiments the flap 46 extends above the canopy to secure the canopy from above the canopy, for example by a wire extending through the securing features 44. The canopy is hung from the securing features 44 and the centre portion of the canopy may not rest on ridge line poles. An example canopy comprising an outwardly extending flap with securing features and a support structure for supporting such a canopy is provided in FIG. 3.

Edges of the canopy may include fastening features. For example the canopy may include a plurality of spaced apart fastening locations, such as rings, hooks or eyes or apertures located near the edge of the canopy.

The sheet material of the canopy may have a tight weave or high weave density so that the canopy has low or negligible water permeability. Additionally or alternatively the web may be coated with a continuous coating of a plastics material for example by extrusion coating at manufacture of the material. Alternatively again the material may be heat treated to melt or partially melt bond the warp and weft tapes together to be water impermeable.

In embodiments of the present invention the canopy 10 comprises vent apertures 30. The vent apertures 30 may allow hot or warm air beneath the canopy to escape from beneath the canopy to ambient air above the canopy. In use, hot air accumulating under the canopy rises towards the ridge of the canopy. Vent apertures near to the top of the canopy near the ridge 12 allow hot air to exit the canopy to ambient air above the canopy. The vent apertures 30 may also allow higher air pressure beneath the canopy, caused by for example wind to escape to lower air pressure above the canopy. In a breezy or windy climate, wind passing below the canopy may cause the canopy to billow outwards, straining any securing features or support structures retaining the canopy in place. The vent apertures may allow wind or breeze to pass through the canopy and reduce billowing of the canopy in a windy climate. The vent apertures may allow cheaper or lighter weight securing devices to be used to secure the canopy.

In some embodiments, a vent cover 34 is provided over each vent aperture. The vent cover or flap restricts water from flowing or entering the vent aperture and passing from outside the canopy to inside the canopy but allows air to move upwards though the vent. The vent apertures assist in maintaining a dry environment under the canopy in at least a central area under the canopy.

In some embodiments the vent apertures 30 are provided near to or adjacent to the centre or ridge line 12 of the canopy. For example, vent apertures may be located at about 10 cm from the centre of the canopy, or 10 cm from the flap 46 comprising the securing features 44.

In some embodiments the canopy may comprise vent apertures 30 located in a longitudinal extending edge region of the canopy to be positioned towards or near to a longitudinal edge of the canopy 10. For example, a longitudinal row or group 51 of vent apertures may be positioned 5 cm to 50 cm, or 5 cm to 30 cm, or 5 cm to 20 cm, or about 10 cm from a longitudinal edge of the canopy. However, the apertures in the edge region may not be aligned in a row.

In some embodiments the canopy may comprise vent apertures 52 located in a longitudinally extending intermediate region of the canopy between a centre 12 or centre region or ridge of the canopy and a longitudinal edge or edge region of the canopy. For example, the canopy may comprise a longitudinal row or group of vent apertures 52 located approximately midway between a centre 12 of the canopy and a longitudinal edge of the canopy. For example, for canopies that are 1 m to 10 m wide, the midpoint for the longitudinal extending intermediate region would be 0.25 m to 2.5 m from the longitudinal edge of the canopy. In some embodiments the longitudinally extending intermediate region of the canopy is between 5 cm from a longitudinal edge of the canopy and 10 cm from a centre 12 of the canopy. In some embodiments the longitudinally extending intermediate region of the canopy is between 10 cm from a longitudinal edge of the canopy and 15 cm from a centre 12 of the canopy. In some embodiments the canopy comprises vent apertures 50 cm to 200 cm, or 50 cm to 150 cm, or 50 cm to 100 cm from a longitudinal edge of the canopy. The apertures may not be aligned in a row.

In some embodiments, the canopy comprises more than one longitudinal row or group of vent apertures. For example, a canopy may comprise more than one of a longitudinal row or group 51 of vent apertures located towards or near to a longitudinal edge of the canopy 10, a longitudinal row or group of vent apertures 52 located approximately midway between a centre 12 of the canopy and a longitudinal edge of the canopy, and a longitudinal row or group of vent apertures 53 located near to or towards a centre 12 of the canopy. The vents could also be placed randomly in each side of the canopy so they are not in a distinct pattern or in rows.

In some embodiments, the canopy sheet material may be reinforced in the regions where vent apertures are located, indicated in FIG. 1 as regions 19, 58 and 59. The reinforced portions of the canopy, whether in a central region 19, an edge region 58, or a region 59 that is intermediate the edge and central regions may comprise heavier warp tapes and/or an additional layer or layers of sheet material and/or an additional plastic coating.

In some embodiments, vent apertures located near to a ridge of the canopy may be spaced apart along the longitudinal direction of the canopy at a distance of 20 cm to 200 cm, 20 cm to 150 cm, 20 cm to 100 cm, or 30 cm to 90 cm, or 40 cm to 80 cm, or 50 cm to 70 cm, or about 60 cm. In some embodiments, vent apertures located intermediate the ridge and longitudinal edge of the canopy may be spaced apart along the longitudinal direction of the canopy at a distance of 50 cm to 200 cm, 50 cm to 130 cm, or 60 cm to 120 cm, or 70 cm to 110 cm, or 80 cm to 100 cm, or about 90 cm. In some embodiments, vent apertures located near to or adjacent a longitudinal edge of the canopy may be spaced apart along the longitudinal direction of the canopy at a distance of 20 cm to 200 cm, 80 cm to 160 cm, or 90 cm to 150 cm, or 100 cm to 140 cm, or 110 cm to 130 cm, or about 120 cm.

In some embodiments, the vent apertures in the longitudinal centre portion or region may be spaced closer together along the length of the canopy compared to the vent apertures in the edge region and/or in the intermediate region. Alternatively, in some embodiments, the vent apertures in the edge region may be spaced closer together than the vent apertures in the centre portion, or may have the same spacing as the vent apertures in the centre region. In some embodiments the vent apertures in the intermediate region may be spaced closer together than the vent apertures in the central region, or may have the same spacing as the vent apertures in the centre region. In some embodiments, the vent apertures in the edge region may be spaced closer together than the vent apertures in the intermediate region, or may have the same spacing as the vent apertures in the intermediate region.

Vent apertures located towards or near to a longitudinal edge of the canopy may be particularly useful for preventing water pooling on top of the canopy in a region extending along a longitudinal edge of the canopy. For example, in use, water running down the canopy may collect in a region near to the longitudinal edge of the canopy where the canopy is installed without sufficient tension to allow water to run off the canopy. The weight of the water can cause the canopy to form a concave shape near the longitudinal edge where water collects and builds up on the canopy. Vent apertures with covers near to the longitudinal edge may act as relief valves to allow water pooling or collecting in this region of the canopy to leak or drain from the canopy to avoid water remaining on or being captured by the canopy or the water is limited to an area beneath the location of the vent apertures in the edge region of the canopy (the amount of water cannot build up towards the centre of the canopy beyond the location of the vent apertures). This reduces the downward water pressure on the canopy caused by pooling water. In some embodiments the vent apertures in the edge region of the canopy are not covered by vent covers, as illustrated in FIG. 2, to allow water at the edge region of the canopy to drain through the canopy via the vent apertures in the edge region. In some embodiments, the vent apertures in the edge region are spaced closer together than the vent apertures in the central region, to provide sufficient vent apertures in the edge region to allow water to leak through the canopy at the edge region to prevent the pooling of water at the edge region of the canopy. For example, in some embodiments, the vent apertures at the edge region are spaced apart by 20 cm to 200 cm, 20 cm to 150 cm, 20 cm to 100 cm, or 30 cm to 90 cm, or 40 cm to 80 cm, or 50 cm to 70 cm, or about 60 cm, whereas the vent apertures in the central region are spaced apart by 80 cm to 160 cm, or 90 cm to 150 cm, or 100 cm to 140 cm, or 110 cm to 130 cm, or about 120 cm.

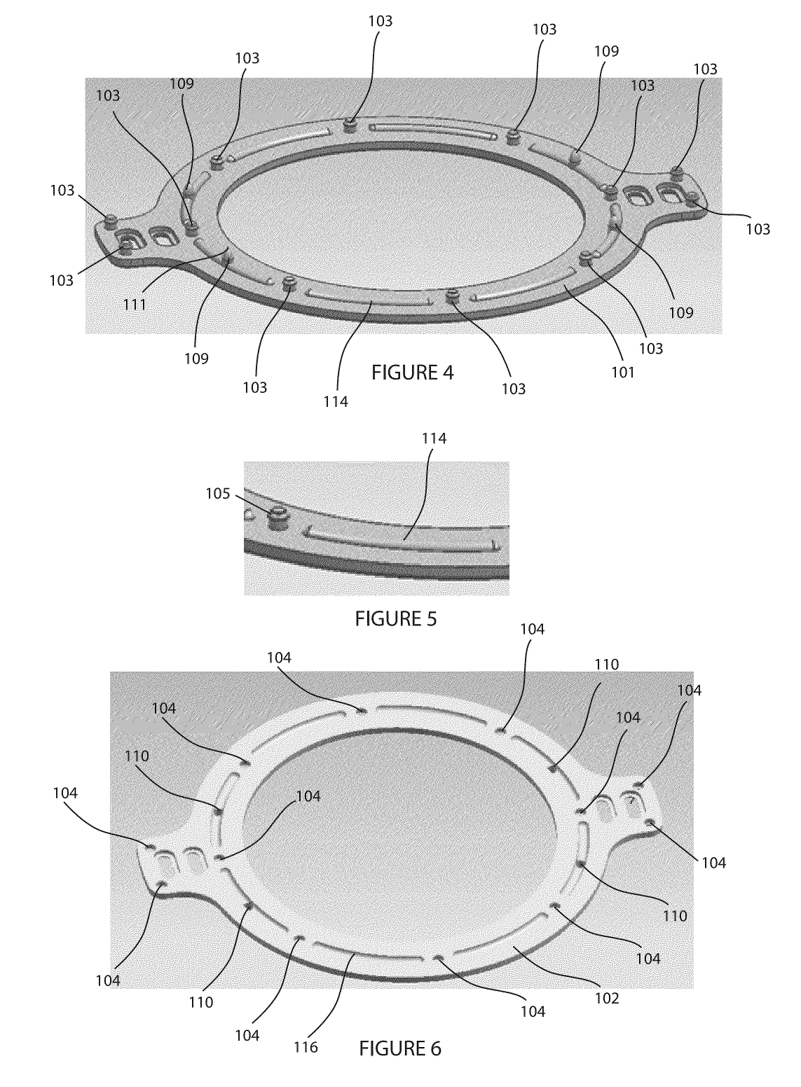

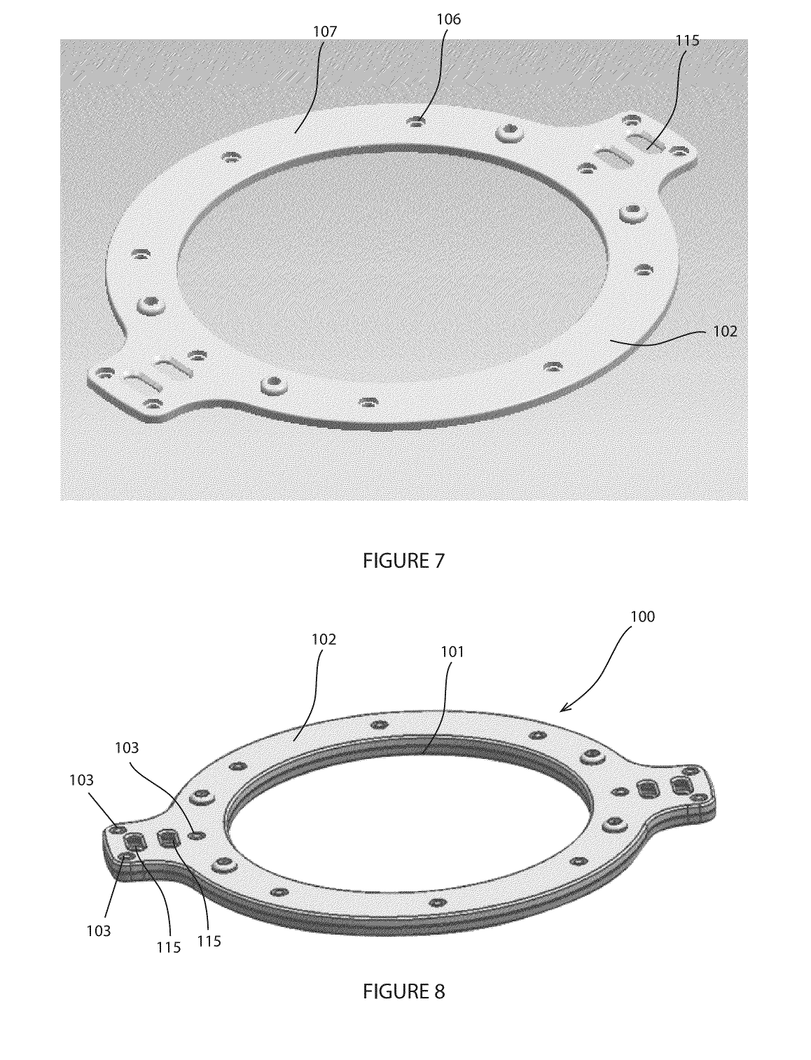

In embodiments according to the present invention the vent apertures 30 are provided with a grommet to provide reinforcing around the vent aperture. A preferred vent aperture grommet is described with reference to FIGS. 4 to 15. A grommet according to embodiments of the present invention comprises a first flange 101 and a second flange 102. The first and second flanges are annular members. The first and second flanges are assembled together with the sheet material 60 of the canopy positioned between the first and second flanges. The first flange 101 comprises pins 103 and the second flange 102 comprises corresponding holes 104 for receiving the pins 103 when the flanges are assembled together. The pins 103 may comprise a rim or lip 105. Once flanges 101 and 102 are assembled together with the sheet material in between, the rim 105 bears against a corresponding outward surface 106 of the second flange to hold the flanges together. Preferably the rim is positioned to set a gap between the flanges that is dimensioned to hold the sheet material 60 (FIG. 10) firmly between the flanges. In some embodiments the position of the rim on the pin 103 is set to provide a gap between the flanges that is slightly smaller than the thickness of the sheet material so that in use, with the pins engaged through the holes of the second flange, the pins are slightly stretched to hold the sheet material tightly between the flanges. In some embodiments the position of the rim is set to provide a gap between the flanges that is about the same size as the thickness of the sheet material. Preferably the first flange has a plurality of pins 103 spaced apart around a circumference of the flange.

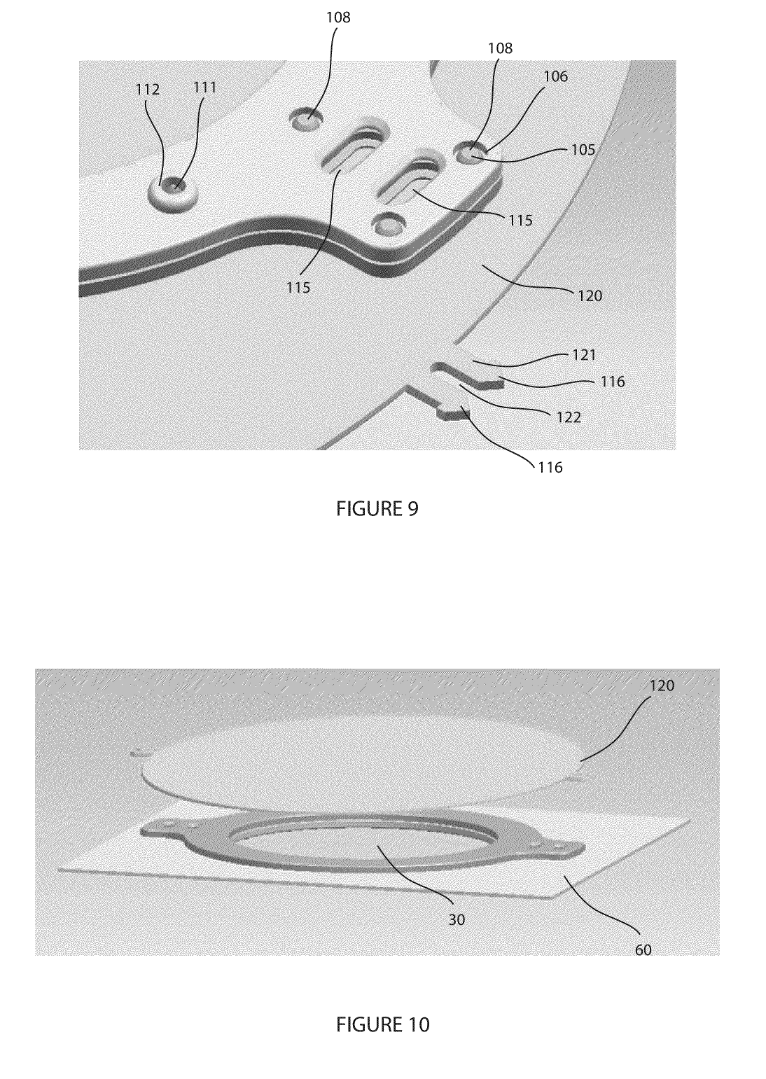

In some embodiments the surface 106 that the rim locks or bears against is recessed from a side 107 of the second flange so that an end 108 of the pin does not protrude from the side 107 of the flange. For example the end of the pin could be flush with or recessed into the side of the flange, as shown in FIG. 9. In some embodiments the rim bears against the side 107 of the flange with the end 108 of the pin proud of the side 107. The pins 103 may be described as locking pins.

In the illustrated embodiment the locking pins have a circular cross section, however the locking pins may comprise a square or rectangular or other cross sectional shape. The term “pin” is intended to mean any feature of the first flange that extends through the sheet material to engage the second flange to hold the two flanges together.

In the illustrated embodiment the pins 103 with rim may be described as being approximately mushroom shaped. However, the pins may be for example ‘T’ shaped, with a head or top of the T extending through a corresponding hole in the second flange. The term “rim” is intended to mean any projection on the pin that extends laterally from the pin to engage a corresponding surface on the second flange to hold the flanges together.

In use the pins 103 of the first flange positioned on one side of the sheet material pierce through the sheet material to engage the holes of the second flange on the other side of the sheet material. A user or canopy manufacturer may press the pins of the first flange through the sheet material, and then engage the second flange with the pins of the first flange to hold the flanges in place on the sheet material. Alternatively, pressing the two flanges together causes the pins to be pierced through the sheet material. In some embodiments the sheet material may be provided with holes for the pins 103 preformed.

In some embodiments the area (i.e. the hole) formed inside the annular flange members has an average diameter of greater than about 1 cm, or between about 1 cm and about 30 cm, or between about 3 cm and about 20 cm, or between about 5 cm and about 10 cm. In some embodiments, the area of the hole is greater than 3 cm2, or between about 3 cm2 and about 3000 cm2, or between about 25 cm2 and about 1500 cm2, or between about 40 cm2 and about 800 cm2, or between about 75 cm2 and about 320 cm2.

With the flanges installed on the sheet material to form a grommet on the sheet material a vent aperture may be formed through the sheet material radially inside the flanges, for example by cutting out a circle of sheet material. Alternatively the vent aperture may be preformed though the sheet material prior to fitting the flanges to the sheet material. In some embodiments the vent aperture and holes for the pins 103 may be pre-formed in the sheet material.

In some embodiments the flanges 101 and 102 comprise complementary features for aligning the flanges together to ensure the locking pins engage the holes 104. For example, in some embodiments one of the first and second flanges comprises at least two alignment pins 109 and the other one of the first and second flanges has corresponding alignment holes 110 for receiving the alignment pins. The alignment pins bear against radial surface or surfaces to align the flanges together. Preferably the alignment pins comprise a conical end or tapered end that tapers to a point 111 to assist with lateral alignment of the flanges. Preferably the alignment pins are longer than the locking pins 103. Preferably an end (e.g. point 111) of the pin 109 is flush or is recessed. For example, the flange may comprise a raised annular portion 112 on the outer side 107 of the flange around the alignment hole so that the tip 111 of the pin 109 is recessed in or flush with an outer surface of the annular portion. In the illustrated embodiment the first flange comprises four alignment pins as shown in FIG. 4. Preferably the flange comprises at least one pair of diametrically opposed alignment pins. In the illustrated embodiment the first flange comprises two pairs of diametrically opposed alignment pins.

In use the alignment pins of one of the first and second flanges positioned on one side of the sheet material pierce through the sheet material to engage the alignment holes of the other flange on the other side of the sheet material. A user or canopy manufacturer may press the alignment pins of one flange through the sheet material, and then engage the other flange, with the alignment pins aligned in the alignment holes of the other flange. Alternatively, pressing the two flanges together causes the alignment pins to be pierced through the sheet material. In some embodiments the sheet material may be provided with holes for the alignment pins 109 preformed.

In some embodiments one of the first and second flanges may comprise at least one projection and the other one of the first and second flanges has a corresponding recess for receiving the projection to provide a non-linear gap between the flanges for receiving the sheet material. In some embodiments one of the first and second flanges comprises a plurality of projections and the other one of the first and second flanges has a corresponding plurality of recesses for receiving the plurality of projections to provide a non-linear gap between the flanges for receiving the sheet material. For example, as shown in FIGS. 4 and 5 the first flange of the illustrated embodiment comprises projections 114 spaced apart around a circumference of the flange. As shown in FIG. 6 the second flange comprises recesses 116 correspondingly spaced apart around a circumference of the flange. In some embodiments as illustrated each projection and corresponding recess extends circumferentially for a portion of a circumference. In some embodiments the projections may be domes circumferentially spaced apart. In the illustrated embodiment projections 114 and locking pins 103 are alternately spaced apart on a circumference about the flange. In some embodiments, the pins 103 may be on a smaller or larger circumference than the projections. In some embodiments one of the first and second flanges comprises a projection or annular bead that extends circumferentially around the flange and the other one of the first and second flanges has a corresponding annular recess that extends circumferentially around the flange for receiving the projection to provide a non-linear gap between the flanges for receiving the sheet material.

By engaging or assembling the two flanges together on the sheet material, the sheet material is caused by the mating of the projections 114 and the recesses 116 to bend through the gap between the two flanges. The recesses and projections help to grip the sheet material between the flanges and secure the grommet in place on the sheet material.

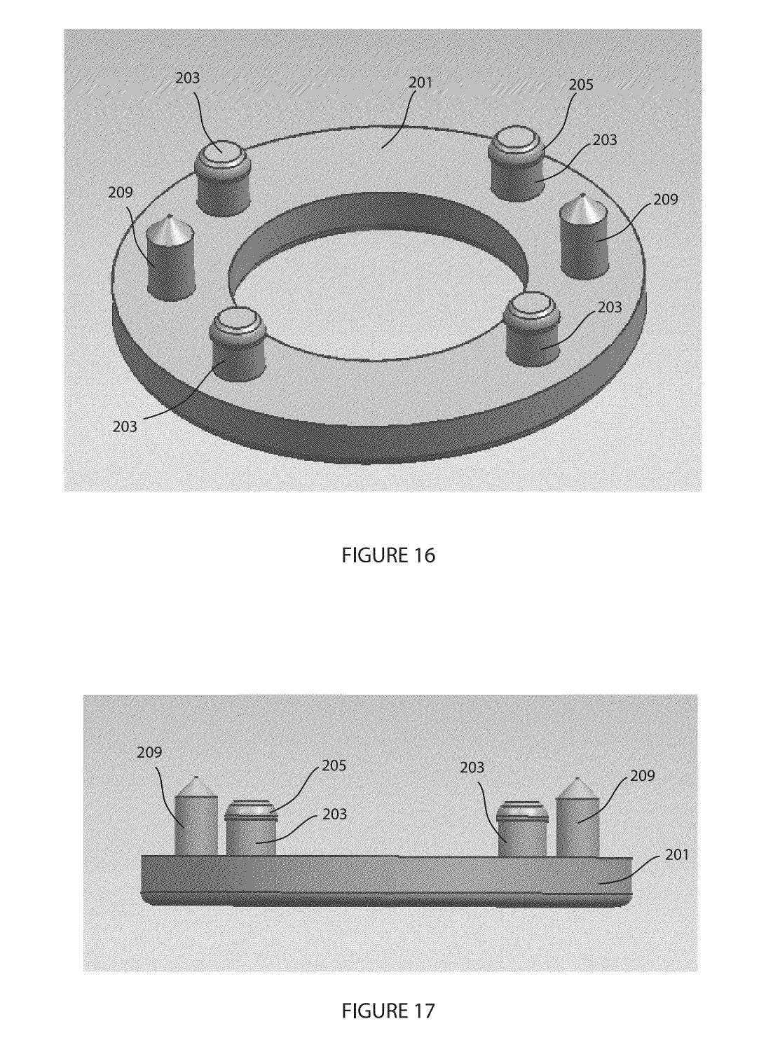

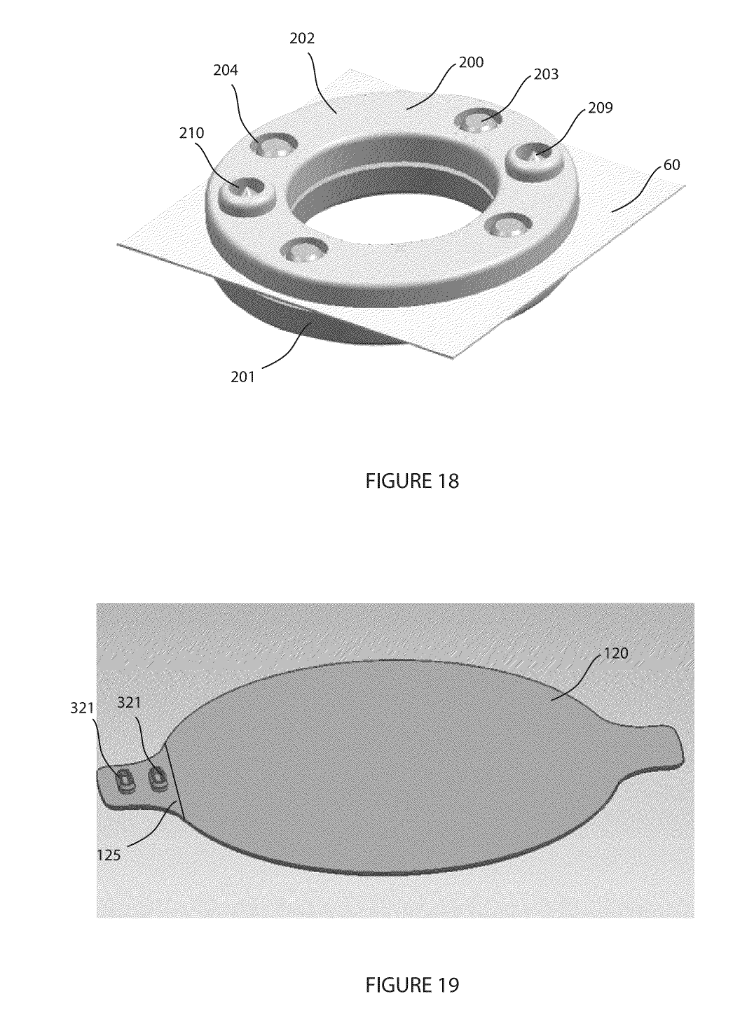

FIG. 18 illustrates a grommet according to another preferred embodiment of the present invention. In the embodiment of FIG. 18, a first flange 201 (illustrated in FIGS. 16 and 17) comprises locking pins 203, and a second flange 202 comprises corresponding holes 204 for receiving the locking pins, as described above with reference to FIGS. 4 to 15). As described earlier, the locking pins have a rim 205 for bearing against an outward facing surface of the second flange. The first and second flanges may comprise alignment features. For example, the first flange may comprise alignment pins 209 and the second flange alignment holes 210, as described with reference to the embodiment of FIGS. 4 to 15. As illustrated in FIG. 17, the alignment pins 209 may be longer than the locking pins 203. Other features described with reference to the embodiment of FIGS. 4 to 15 may also be incorporated into the embodiment illustrated in FIG. 17.

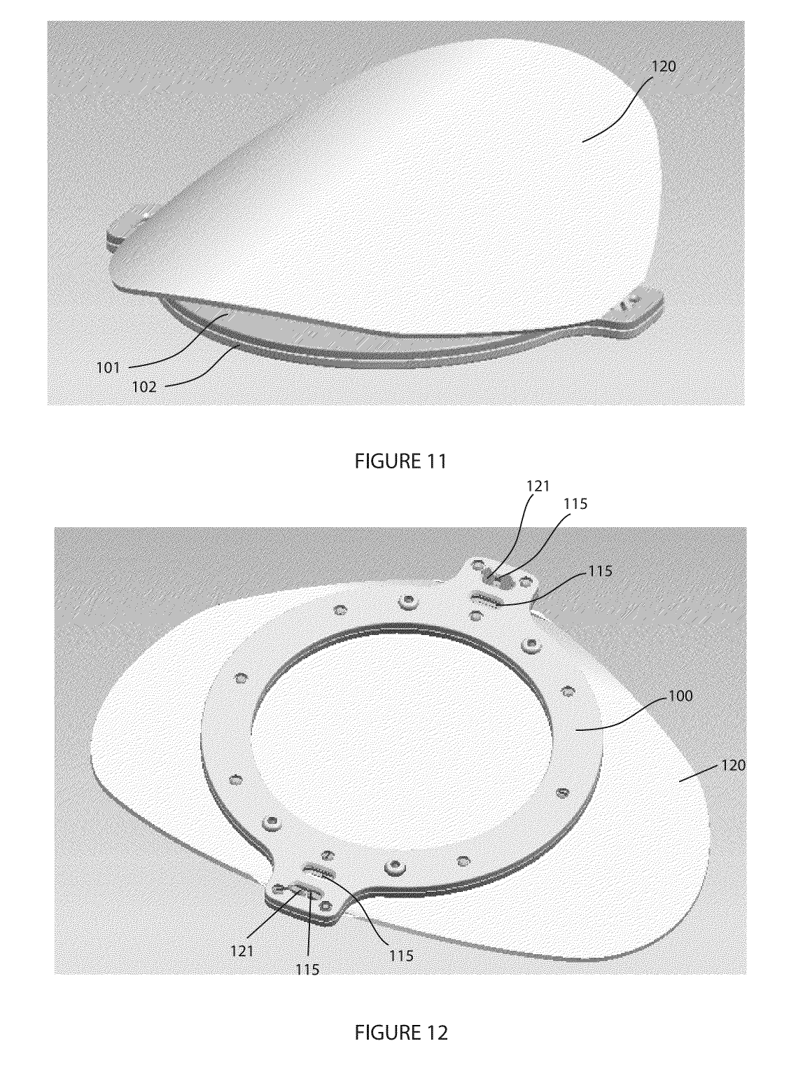

In some embodiments the grommet may be provided with a cover for covering the vent aperture 30. The vent cover restricts water from flowing or entering the vent aperture and passing from outside the canopy to inside the canopy but allows air to move upwards through the vent. For example, as shown in FIG. 11, the grommet may be provided with cover 120. Preferably the vent cover is attached to the grommet at a position that is above the vent aperture 30 in use, that is, attached to the side of the grommet closest to the ridge line 12 of the canopy in use (i.e. the higher side of the aperture).

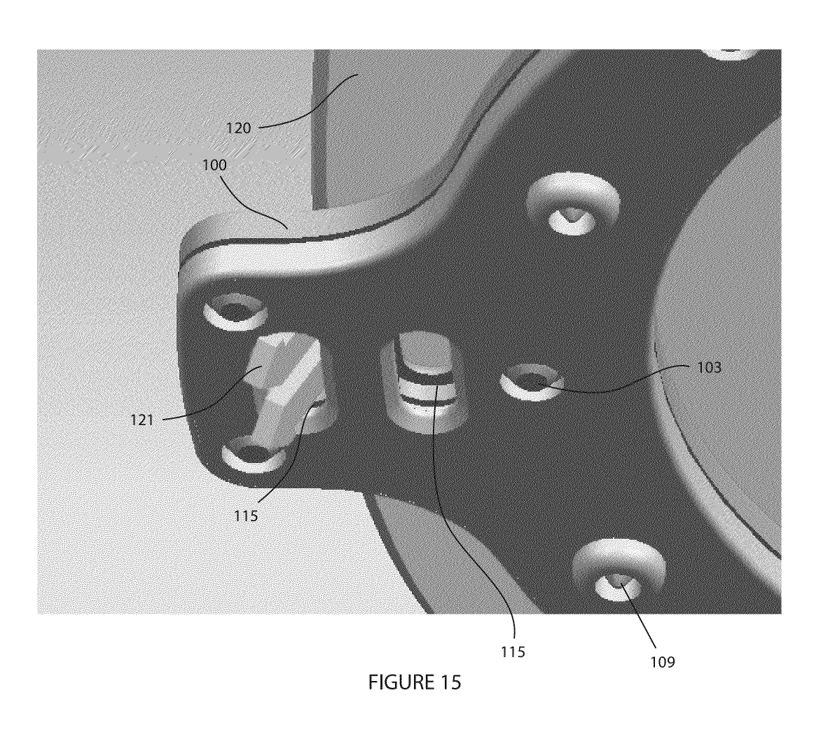

In some embodiments the vent cover is removably attached to the grommet. The vent cover may be removed from the grommet for transporting the canopy so that the vent cover is not damaged during transportation. The cover may be removably clipped to one or both of the flanges 101, 102. For example, the cover 120 may comprise a tab to be received in an aperture or slot in one or both of the flanges. In the illustrated embodiment, the cover comprises a tab 121 (for example as shown in FIG. 9) that is received in a slot 115 in the first and second flanges. The cover 120 is attached to the grommet by inserting the tab into the slot 115, as shown in FIG. 15. Preferably the tab has a broad end or head or is approximately T shaped to retain the tab in the slot 115 once the head is inserted through the slot. In some embodiments the tab comprises a slot 122 to allow sides of the tab to deflect inwards so that the head 116 of the tab may be inserted more easily through the slot 115. In some embodiments a hole is provided in the sheet material of the canopy aligned with the slot so that in use the tab of the cover extends through the slot 115 in the grommet and also through an aligned hole or slot in the sheet material. The slot 115 is provided to a side of the grommet to be positioned above the vent aperture 30 in use.

The tab is illustrated as having an approximately rectangular shaped cross section divided by the slot 122. In some embodiments the tab may have a circular cross section, and may comprise a rim, similar in form to the locking pin 103 described earlier but in some embodiments may also comprise a slot 122 as described with reference to the illustrated embodiment provided by way of example.

In some embodiments the tab is inserted into a hole or slot at one side of the grommet. The vent cover may lie flat against the grommet when in a closed configuration. The weight of the vent cover may determine the amount of air pressure that can build up under the canopy. Once a sufficient pressure builds up under the canopy (accumulated hot air or a breeze for example) the pressure lifts the cover away from the grommet to allow the air pressure to vent from beneath the canopy to above the canopy.

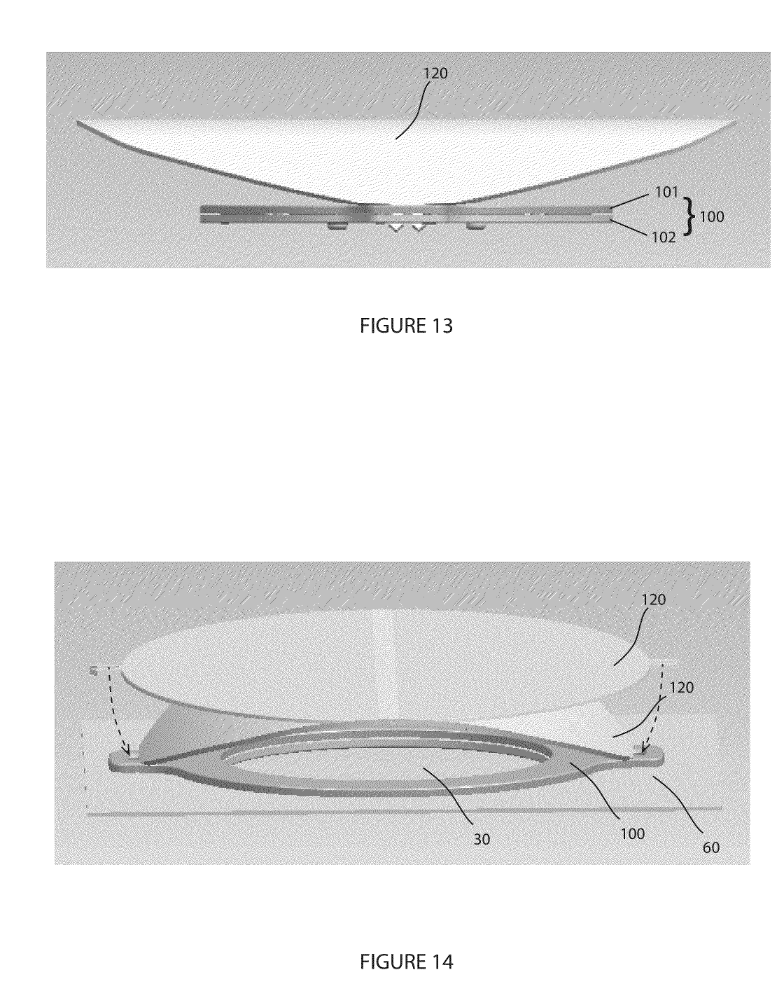

In some embodiments the grommet comprises a slot 115 at each side of the grommet, and the cover comprises a tab at each side of the cover to engage the slots at each side of the grommet. Preferably the cover comprises a lateral dimension between the tabs 121 that is greater than a lateral dimension between the slots 115 so that when the cover is attached to the grommet the cover arches or bows outwardly from the vent aperture 30. This helps to ensure the vent cover is spaced a distance from the vent aperture, even when there is no substantial breeze or air flow passing through the vent aperture. With the vent cover held or bowed outwards from the vent aperture, a low resistance path for venting air from below the canopy is provided, while the vent aperture remains covered by the cover. FIG. 13 illustrates how the vent cover is bowed from being straight to attach the cover to the slots at each side of the grommet.

In some embodiments the grommet is provided with at least two slots in at least one side of the grommet. For example, in the illustrated embodiment of FIGS. 4 to 15, the grommet comprises two slots 115 at each side of the grommet. This arrangement provides for three different amounts of bow in the cover 120. As shown in FIG. 12, the cover may be attached to the outer most slots 115 to provide a smaller amount of bow in the cover. In an alternative configuration the cover may be fitted to the inner most slots to provide a greater amount of bow in the cover. Alternatively the cover may be fitted to an outer slot on one side and an inner slot on the other side to provide an intermediate amount of bow in the cover. Depending on weather conditions, for example the amount of rain or breeze, or the air temperature, one of the three configurations may be preferred. In some embodiments the grommet may be provided with one slot at one side and many slots on the opposite side, or may comprise more than two slots at each side.

In some embodiments the slot or slots 115 are positioned between locking features of the first and second flanges so that the flanges are held securely together at the location of the slots. For example, as shown in FIG. 8 the slots 115 are located between three locking pins and corresponding locking pin holes of the first and second flanges. In some embodiments slots may be located between two pins 103, or three pins or more than three pins.

In some embodiments the cover is formed as a flat component, and is bent into a bowed shape when fitting to the grommet. For example, as shown in FIG. 14, the cover is illustrated in both an uninstalled straight position and also a curved or bowed installed position.

In some embodiments the vent cover does not extend beyond a perimeter of the grommet or is approximately the same size as the grommet. As shown in FIGS. 12 and 13, in some embodiments the cover may comprise a longitudinal dimension greater than a longitudinal dimension of the vent aperture 30. That is, the cover extends longitudinally beyond vent aperture. In some embodiments the cover 120 extends longitudinally beyond the grommet 100. For example, in some embodiments the longitudinal dimension of the vent cover is at least 1.5 times the diameter (or the longitudinal dimension) of the vent aperture. In some embodiments the longitudinal dimension of the vent cover is at least 2 times the diameter (or the longitudinal dimension) of the vent aperture.

The longitudinal direction of the vent cover and grommet is parallel to a length direction of the canopy (that is, the direction that is along the length of the canopy). The lateral direction of the vent cover and grommet is parallel to a width direction of the canopy (that is, the direction that is along the width of the canopy and perpendicular to the length direction of the canopy).

In some embodiments the vent cover may be attached to one of the first and second flanges by a hinged portion. For example, the vent cover may be integrally formed with one of the first and second flanges via a folded section. That is, the cover is integrally formed with one of the first and second flanges and folded about an edge of the flange to lie over the grommet. The vent cover may lie flat against the grommet when in a closed configuration. In some embodiments the vent cover may be movably attached to the grommet by a hinge. The weight of the vent cover may determine the amount of air pressure that may build up under the canopy. Once a sufficient pressure builds up under the canopy (accumulated hot air or a breeze for example) the pressure lifts the cover away from the grommet to allow the air pressure to vent from beneath the canopy to above the canopy. For example, the thicker a vent cover 120 the heavier the vent cover will be to provide a higher venting pressure for the vent aperture. A range of different thickness or weight covers may be provided to allow a user to select a preferred vent pressure for the apertures in a canopy.

In some embodiments the grommet may comprise a slot 115 at one side of the grommet and the cover may be attached to the grommet by a hinged portion on an opposite side of the grommet. The cover may comprise a tab 121 to engage the slot to hold the cover closed. In some embodiments a lateral dimension between the hinge and the tab 121 is greater than a lateral dimension between the hinge and the slot 115 so that when the tab is engaged with the slot the cover arches or bows outwardly from the vent aperture 30. A number of slots may be provided to provide for different amounts of bow in the cover 120.

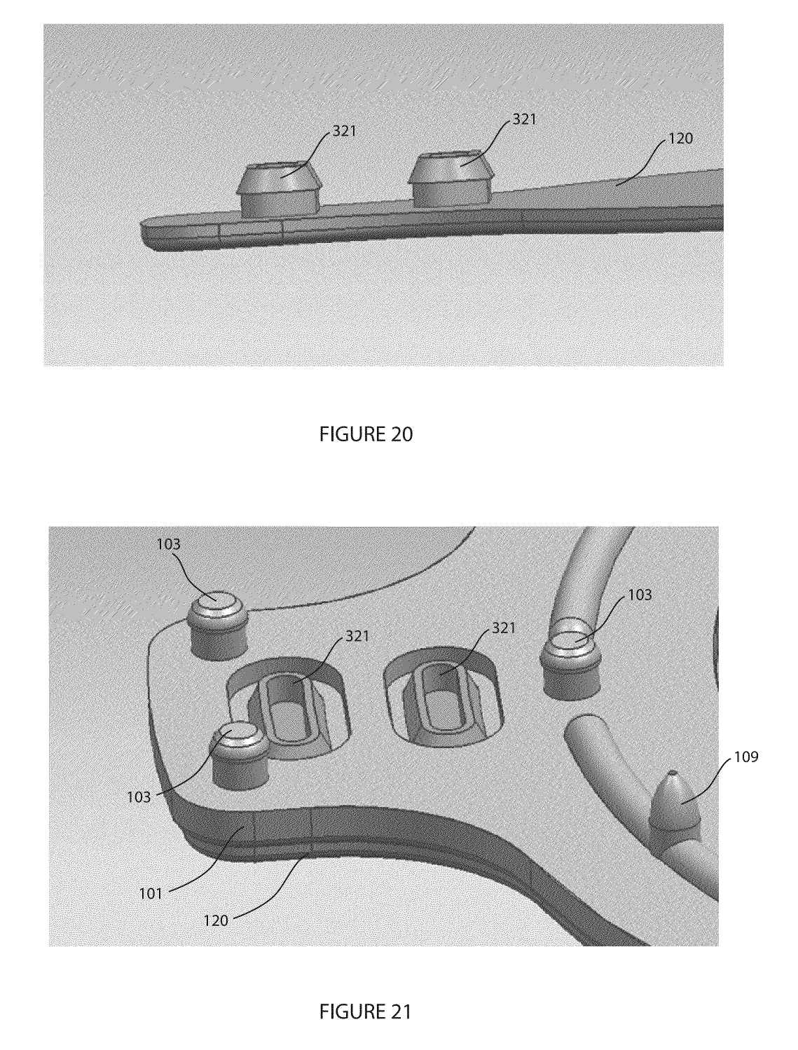

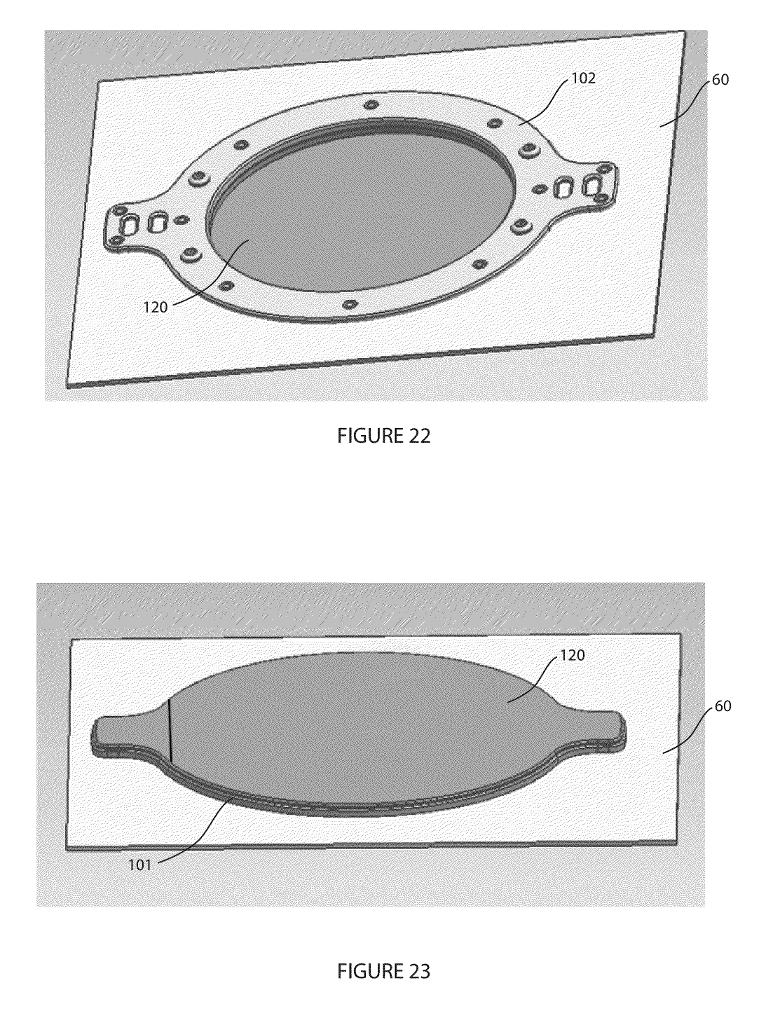

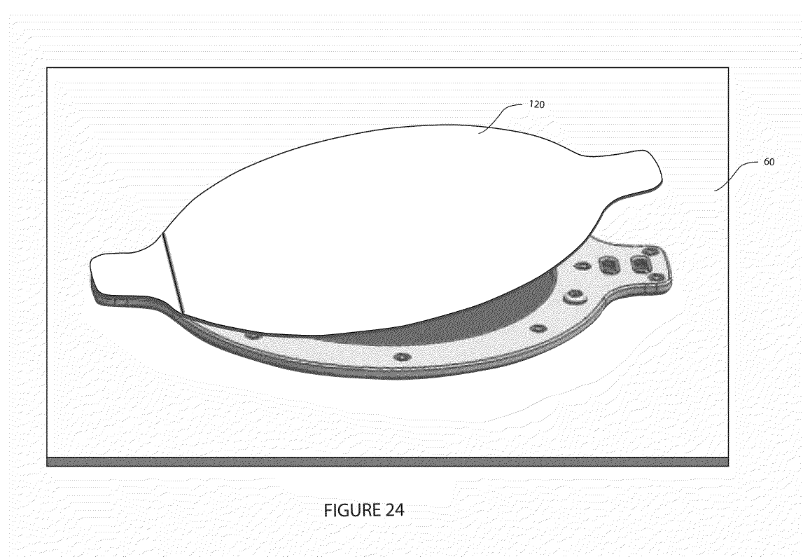

In the embodiment of FIGS. 9 to 15 the tab 121 extends from an edge of the vent cover. Alternatively, in some embodiments, for example as shown in FIGS. 19 to 23, the vent cover comprises a tab or pin 321 extending from an inner side of the vent cover. In the embodiment of FIGS. 19 to 23 the pin extends laterally from the inner side of vent cover. The pin 321 is received in a corresponding slot 115 in one or both of the first and second flanges 101 and 102 to attach the cover to the grommet. In the illustrated embodiment the cover 120 comprises two tabs or pins 321 to be received in two slots 115 in the flange. The cover pin 321 may comprise a rim, similar in form to the locking pin 103 described earlier. The pin 321 may comprise a slot 122 as described with reference to the embodiment of FIGS. 9 to 15. The pin 321 may form a plug to fill or seal the slot 115. In some embodiments the pin 321 may engage a slot 115 in one of the first and second flanges. For example, as shown in FIG. 21, the pin 321 is received in a slot in the first flange 101. An end of the pin may be flush or recessed from an inner side of the flange 101 when the cover is attached to the flange (as illustrated in FIG. 21) so that the pin does not extend through the sheet material when the flanges are assembled together with the sheet material positioned between the flanges. In such an embodiment a slot in the sheet material is not required for the pin 321, as shown in FIG. 22. In the embodiment of FIGS. 19 to 24 the cover may lie flat in a closed position over the vent aperture. Air pressure underneath the canopy may cause the vent cover to lift off the aperture to allow the air pressure to vent to above the canopy by bending away from the grommet. In some embodiments air pressure causes the vent cover to elastically bend away from the grommet. In a closed position the vent cover is in an un-deflected position, as illustrated in FIG. 23. To move from the closed position towards or to an open position the vent cover elastically bends away from the grommet. For example, the vent cover may bend into a curve over the length of the cover, one end of the cover attached to the grommet by the tab or pin and an opposite end lifted off the grommet, as illustrated in FIG. 24. The vent cover in FIG. 24 is shown as being partially lifted or partially open. In higher wind conditions, the vent cover may bend further away from the aperture so that the vent aperture is more open, or, in some embodiments, in very high wind conditions the vent cover may lift to be generally perpendicular to the plane of the canopy, such that the aperture is completely open. Another situation is warm air beneath the canopy can cause the flap to rise and open to allow the warm air to escape. The stiffness of the vent cover material biases the vent cover to the closed or flat position over the vent aperture. The cover acts as a cantilevered leave spring. The cover weight can be varied (by the thickness of the plastic, or by its pigmentation level, specific gravity) to influence the air pressure at which it releases air. In some embodiments, the cover may comprise a fold region or fold line 125 as shown in FIG. 19. The fold line may be a crease or reduced thickness portion of the cover so that the cover may fold or bend at the fold line. Air pressure causes the vent cover to lift off the grommet from a flat position by folding at the fold line. The fold line may be described as a hinge.

The weight or stiffness of the vent cover may determine the amount of air pressure that may build up under the canopy. Once a sufficient pressure builds up under the canopy (accumulated hot air or a breeze for example) the pressure lifts the cover away from the grommet to allow the air pressure to vent from beneath the canopy to above the canopy. For example, the thicker a vent cover 120 the heavier and/or stiffer the vent cover will be to provide a higher venting pressure for the vent aperture. A range of different thickness, stiffness or weight covers may be provided to allow a user to select a preferred vent pressure for the apertures in a canopy.

The grommet and/or the vent cover may be formed from any suitable polyolefin such as polyethylene or polypropylene, for example, or a mixture thereof, or an ethylene alpha-olefin, or a polyester, or a biopolymer, or a blend of any of the foregoing. Certain plastics are particularly useful when present as minor or major components. Ethylene vinyl acetate (EVA), ethylene butyl acrylate (EBA) and ethylene methyl acrylate (EMA) are useful for imparting elasticity and other properties. The grommet and vent cover can also be made from polyamide (nylon). Polyamides, polyesters, and polystyrene, styrene-butadiene (SB), acrylonitrile-butadiene-styrene (ABS), styrene-acrylonitrile (SAN), polyethylene terephthalate (PET), polymethylmethacrylate (PMMA) and polycarbonate.

In some embodiments the grommet is formed from nylon. In some embodiments the cover is formed from high-density polyethylene (HDPE).

In some embodiments the vent cover may be formed from a fabric material providing a low venting pressure. For example a clip comprising pins 321 may be attached (e.g. by stitching) to a fabric vent cover. In some embodiments the vent cover 120 may be formed from the sheet material 60 of the canopy.

The foregoing describes the invention including preferred forms thereof. Alterations and modifications as will be obvious to those skilled in the art are intended to be incorporated in the scope hereof as defined in the accompanying claims.

1. A grommet adapted to be assembled with a sheet material around an aperture in the sheet material comprising a first flange and a second flange adapted to be assembled together with the sheet material positioned between, the first flange comprising locking pins to extend through the sheet material around the aperture and the second flange comprising corresponding holes for receiving the locking pins, each locking pin comprising a rim that bears against a corresponding surface of the second flange to hold the flanges together.

2. A grommet according to claim 1 wherein the rim is positioned on the locking pin to set a gap between the flanges that is dimensioned to hold the sheet material between the flanges.

3. A grommet according to claim 1 wherein the rim is positioned on the locking pin to set a gap between the flanges that is smaller than the thickness of the sheet material.

4. A grommet according to claim 1 wherein the first flange has a plurality of locking pins spaced apart around a circumference of the flange.

5. A grommet according to claim 1 wherein the rim locks or bears against a recessed surface of the second flange.

6. A grommet according to claim 5 wherein the rim locks or bears against a surface of the second flange recessed from a side of the second flange so that an end of the locking pin does not protrude from the side of the flange.

7. A grommet according to claim 1 wherein the first and second flanges comprise complementary features for aligning the flanges together.

8. A grommet according to claim 7 wherein one of the first and second flanges comprises at least two alignment pins and the other one of the first and second flanges comprises corresponding alignment holes for receiving the alignment pins.

9. A grommet according to claim 1 wherein one of the first and second flanges comprises at least one projection and the other one of the first and second flanges comprises a corresponding recess for receiving the projection to provide a non-linear gap between the flanges for receiving the sheet material.

10. A grommet assembly for use with a sheet material around an aperture formed in the sheet material, comprising:
a first flange and a second flange adapted to be assembled together with the sheet material positioned between, the first flange comprising locking pins to extend through the sheet material around the aperture and the second flange comprising corresponding holes for receiving the locking pins, each locking pin comprising a rim that bears against a corresponding surface of the second flange to hold the flanges together; and
a vent cover adapted to be attached to the grommet to cover the aperture.

11. The grommet assembly according to claim 10, wherein the vent cover is attached to one of the first and second flanges by a hinged portion.

12. The grommet assembly according to claim 11, wherein the vent cover, hinged portion and one of the first and second flanges is integrally formed, the vent cover folded about an edge of the flange to lie over the aperture.

13. The grommet assembly according to claim 10, wherein the vent cover is removably attached to one of the first and second flanges.

14. The grommet assembly according to claim 10, wherein the vent cover comprises a tab or pin to be received in a hole or slot in one or both of the first and second flanges.

15. The grommet assembly according to claim 10, wherein in a closed position over the aperture the vent cover is in an un-deflected position, the vent cover adapted to deflect elastically to bend away from the aperture, the stiffness of the vent cover biasing the vent cover to the closed position.

16. The grommet assembly according to claim 14, wherein the grommet comprises a slot or hole at each side of the first flange or the second flange or both, and the cover comprises a tab at each side of the cover to engage the slot or hole at each side of the flanges.

17. The grommet assembly according to claim 16, wherein the vent cover comprises a lateral dimension between the tabs that is greater than a lateral dimension between the slots or holes at each side of the flanges so that when the vent cover is attached to the flanges the vent cover arches or bows outwardly from the aperture.

18. The grommet assembly according to claim 10, wherein the vent cover arches or bows outwardly from the aperture.

19. The grommet assembly according to claim 16, wherein the grommet comprises at least two said holes or slots on one side of the first or second flange.

20. The grommet assembly according to claim 19, wherein the grommet comprises at least two said holes or slots at each side of the first or second flange.

21. The grommet assembly according to claim 14, wherein the vent cover comprises a longitudinal dimension greater than a longitudinal dimension of the aperture.

22. The grommet assembly according to claim 21, wherein the vent cover extends longitudinally beyond the first or second flange.

23. A canopy comprising:
a sheet material having a greater length than width;
a plurality of apertures in the sheet material; and
a plurality of grommets, each grommet provided around each said aperture, each grommet adapted to be assembled with the sheet material around the aperture in the sheet material, each grommet comprising first and second flanges adapted to be assembled together with the sheet material positioned between, the first flange comprising locking pins to extend through the sheet material around the aperture and the second flange comprising corresponding holes for receiving the locking pins, wherein locking pin comprises a rim that bears against a corresponding surface of the second flange to hold the flanges together.

24. The canopy according to claim 23, further comprising a
plurality of vent covers, each vent cover adapted to be attached to beach said grommets to cover the apertures.
